(19) United States
(12) Patent Application Publication
(10) Pub. No.: US 2004/0052382 A1
(43) Pub. Date: Mar. 18, 2004

(54) Automatic switching bi-directional vehicle-used speaker

(76) Inventor: Wen Chieh Wang, Taipei (TW)

Correspondence Address: Wen Chieh Wang, 235 Chung-Ho, Box 8-24, Taipei, TW

(21) Appl. No.: 10/244,836

(22) Filed: Sep. 17, 2002

(51) Int. Cl. H04B 1/00

(52) U.S. Cl. 381/86

(57) ABSTRACT

An automatic switching bi-directional vehicle-used speaker comprises a handset having a standard wireless communication protocol and a wireless earphone. The handset and wireless earphone transmitting speech signals bi-directionally. The wireless earphone is installed on a speaker device. A switch is used to switch the speech signal from the handset to the wireless earphone so that the signal is emitted through the speaker device. The microphone built in the speaker device receives speech signals of a user and then the speech signals are sent to the handset through the wireless earphone for emission. By above mentioned structure, the wireless earphone is placed in the speaker device. By the speaker device, speech signals are sent bi-directionally. Thereby, the user can communicate through the handset without wearing a wireless earphone.

### FIELD OF THE INVENTION

The present invention relates speakers, and particularly to an automatic switching bi-directional vehicle-used speaker, wherein speech can be emitted through a speaker device and speech signals is received with a built-in microphone. Then, the speech signals can be sent to a handset to be transmitted. Thereby, the user does not need to wear a wireless earphone so as to reduce the bad effect from electromagnetic wave of the wireless earphone.

### BACKGROUND OF THE INVENTION

With the rapid growth in the demand of wireless communication, hand free devices used within vehicles are popular and recently, these devices are combined with audio phones to further expand the convenience of the device. That is, the handset is placed in a proprietary connecting seat so that the user may communicate with a predetermined microphone through a speaker device. Thereby, the speech can be transmitted bi-directionally with a hand free handset. However, this device is equipped at the time that a car is manufactured and in general, it can not be added after the user buys the car. Otherwise, the manufacturers has no any responsibility as destroy occurs due to add the device. Thereby, when above mentioned device is added, some electric wires and stereos are necessary to be detached and thus time and labor are increased. Moreover, the connecting seat is specific and thus can not match to different handsets. Thereby, the user suffers from many limitations.

To improve above mentioned defects, a wireless earphone bi-directionally transmitting with a handset, for example, a wireless blue-tooth earphone of Ericesson) can be worn upon the head of a user. Thereby, the user can hand-freely and bi-directionally communicate with a handset by a standard frequency band. However, since this prior art earphone must be worn around the head, the electromagnetic wave will make the user feel uneasy. Thereby, the earphone will affect the user to view asides.

### SUMMARY OF THE INVENTION

Accordingly, the primary object of the present invention is to provide an automatic switching bi-directional vehicle-used speaker, wherein when the user enters into a car, the wireless earphone can be positioned to a speaker device. Meanwhile, speech can be emitted through a speaker device and receive speech signals with a built-in microphone. Then, the speech signals can be sent to the handset to be transmitted. Thereby, the user does not need to wear a wireless earphone so as to reduce the bad effect from electromagnetic wave of the wireless earphone.

Another object of the present invention is to provide an automatic switching bi-directional vehicle-used speaker, wherein the speaker device can be combined to an wireless earphone so that speech signal can be transmitted bi-directionally so that a space is formed for placing the wireless earphone. Moreover, when the wireless earphone is placed idly, it can be charged.

Another object of the present invention is to provide an automatic switching bi-directional vehicle-used speaker, wherein the speaker device of the present invention is connected to a vehicle power source (or a standby power source seat or cigarette firing seat).

To achieve above object, the present invention provides an automatic switching bi-directional vehicle-used speaker comprising a handset having a standard wireless communication protocol and a wireless earphone. The handset and wireless earphone transmitting speech signals bi-directionally. The wireless earphone is installed on a speaker device. A switch is used to switch the speech signal from the handset to the wireless earphone so that the signal is emitted through the speaker device. The microphone built in the speaker device receives speech signals of a user and then the speech signals are sent to the handset through the wireless earphone for emission. By above mentioned structure, the wireless earphone is placed in the speaker device. By the speaker device, speech signals are sent bi-directionally. Thereby, the user can communicate through the handset without wearing a wireless earphone.

The various objects and advantages of the present invention will be more readily understood from the following detailed description when read in conjunction with the appended drawing.

### BRIEF DESCRIPTION OF THE DRAWINGS

FIG. 1 is a schematic view showing the device of the present invention.

FIG. 2 is an assembled schematic view showing the wireless earphone and speaker device of the present invention.

FIG. 3 is an assembled perspective view of the wireless earphone and speaker device of the present invention.

FIG. 4 is a perspective view of FIG. 3 which is viewed from another orientation.

### DETAILED DESCRIPTION OF THE PREFERRED EMBODIMENTS

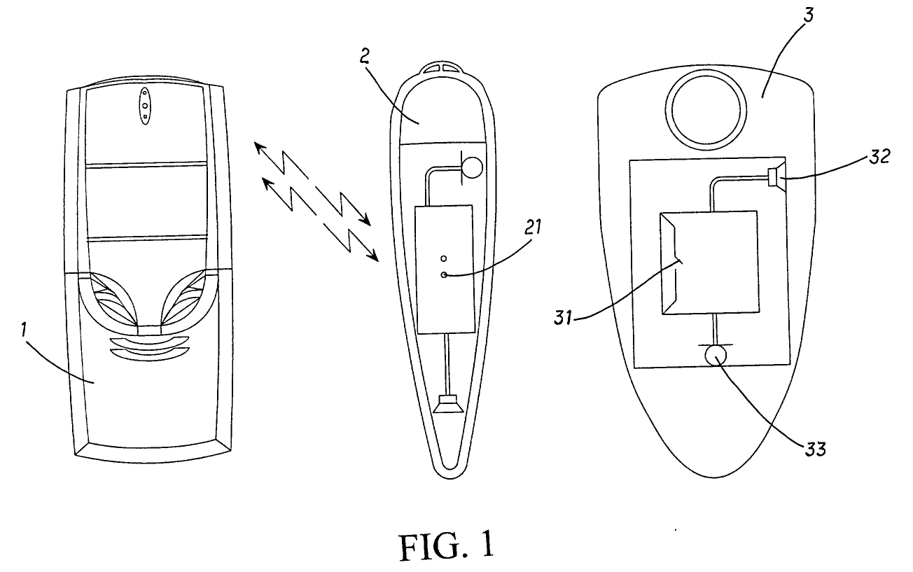

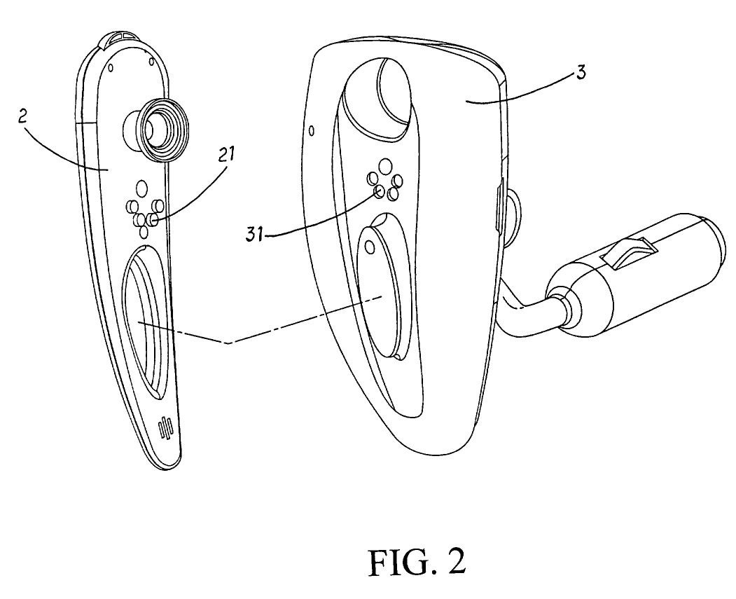

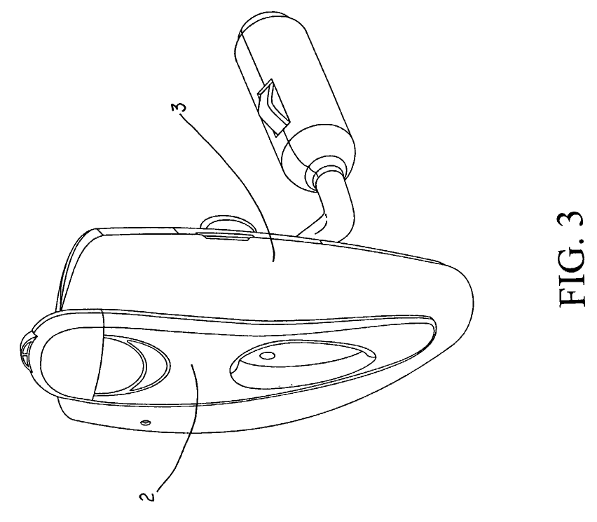

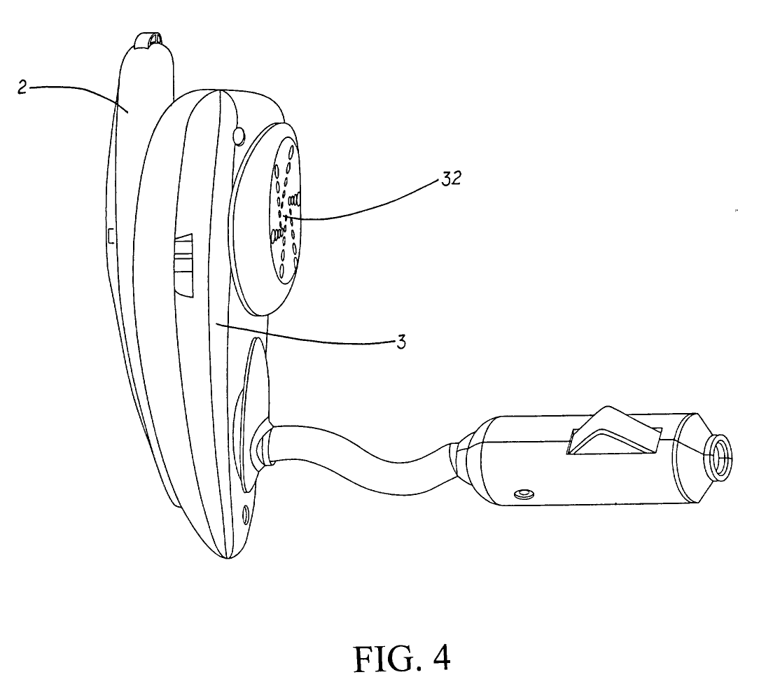

Referring to FIGS. 1 and 2, the automatic switching bi-directional vehicle-used speaker of the present invention is illustrated. The speaker of the present invention includes a handset 1 having a standard wireless communication protocol and a wireless earphone 2. The handset 1 and wireless earphone 2 may transmit speech signals bi-directionally. The wireless earphone 2 can be installed on a speaker device 3. The electric joints 21 and 31 serve to conduct the wireless earphone 2 and the speaker device 3. A switch is used to switch the speech signal from the handset 1 to the wireless earphone 2 so that the signal is emitted through the speaker device 3. The microphone built in the speaker device 3 can receive the speech of the user and then the speech signal is sent to the handset 1 through the wireless earphone 2 for emission. By above mentioned structure, referring to FIGS. 3 and 4, the wireless earphone 2 can be placed in the speaker device 3. By the speaker device 3, the speech signal can be sent bi-directionally. Thereby, the user can communicate through the handset 1 without wearing a wireless earphone 2. Moreover, the speaker device 3 of the present invention is connected to a vehicle power source (or a standby power source seat or cigarette firing seat). Further, when the wireless earphone 2 is positioned to the speaker device 3, the wireless earphone 2 can be charged. Thereby, the present invention is a multi-functional device.

In above structure, the handset 1 and wireless earphone 2 are built with blue-tooth protocol.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An automatic switching bi-directional vehicle-used speaker comprising a handset having a standard wireless communication protocol and a wireless earphone; the handset and wireless earphone transmitting speech signals bi-directionally; characterized in that:
the wireless earphone is installed on a speaker device; a switch is used to switch speech signals from the handset to the wireless earphone so that the signal is emitted through the speaker device; a microphone built in the speaker device receives speech signals and then the speech signals are sent to the handset through the wireless earphone for emission;
wherein by above mentioned structure, the wireless earphone is placed in the speaker device; by the speaker device, speech signals are sent bi-directionally; thereby, the user can communicate through the handset without wearing an wireless earphone.

2. The automatic switching bi-directional vehicle-used speaker as claim in claim 1, wherein the handset and wireless earphone are built with blue-tooth protocol.

3. The automatic switching bi-directional vehicle-used speaker as claim in claim 1, wherein the wireless earphone and speaker device has electric joints, respectively, when the wireless earphone is positioned on a speaker device; the wireless earphone and speaker device are communicated with one another; the speaker device serves to bi-directionally transmit speech signals.

4. The automatic switching bi-directional vehicle-used speaker as claim in claim 1, wherein the speaker device is connected to a vehicle power source; thereby, when the wireless earphone is positioned to the speaker device, the wireless earphone is charged.
